(19) United States
(12) Patent Application Publication
(10) Pub. No.: US 2014/0143779 A1
(43) Pub. Date: May 22, 2014

(54) CONTEXTUAL ROUTING OF DATA ELEMENTS

(71) Applicant: RAYTHEON COMPANY, Waltham, MA (US)

(72) Inventors: Danielle J. Marchione, Vienna, VA (US); Marc Berte, Arlington, VA (US)

(73) Assignee: Raytheon Company, Waltham, MA (US)

(21) Appl. No.: 13/680,565

(22) Filed: Nov. 19, 2012

(51) Int. Cl. G06F 9/46

(52) U.S. Cl. CPC G06F 9/46
USPC 718/100

(57) ABSTRACT

A method for processing data includes receiving a data element in a first processing node, the data element including data, reading a first control word in data element and perform a first processing task with the data with a processing portion of the first processing node, the first processing task associated with the first control word, adding a first sub-header associated with the first processing task to the data element, adding metadata associated with the first processing task to the data element, removing the first control word from the data element, determining whether a second processing task should be performed with the data, and adding a second control word to the data element responsive to determining that a second processing task should be performed with the data.

### BACKGROUND

The present disclosure relates to data processing, and more specifically, to message based control based context routing.

Processing tasks such as iterative and recursive processing of data elements may be performed on a network having a variety of processing nodes that are operative to perform specific processing tasks.

### SUMMARY

According to one exemplary embodiment, a method for processing data includes receiving a data element in a first processing node, the data element including data, reading a first control word in data element and perform a first processing task with the data with a processing portion of the first processing node, the first processing task associated with the first control word, adding a first sub-header associated with the first processing task to the data element, adding metadata associated with the first processing task to the data element, removing the first control word from the data element, determining whether a second processing task should be performed with the data, and adding a second control word to the data element responsive to determining that a second processing task should be performed with the data.

According to another exemplary embodiment, a system for processing data includes a first processing node comprising a processor operative to receive a data element in a first processing node, the data element including data, reading a first control word in data element and perform a first processing task with the data with a processing portion of the first processing node, the first processing task associated with the first control word, add a first sub-header associated with a first processing task to data element add metadata associated with first processing task to data element, remove the first control word from data element, determine whether a second processing task should be performed with the data, and add a second control word to the data element responsive to determining that a second processing task should be performed with the data.

According to yet another exemplary embodiment, A method for processing data includes receiving a data element including data, performing a first processing task with the data with a processor, determining whether a time to delete is associated with a result of the first processing task, adding a time to delete to the data element responsive to determining that a time to delete is associated with a result of the first processing task.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

The subject matter which is regarded as the disclosure is particularly pointed out and distinctly claimed in the claims at the conclusion of the specification. The forgoing and other features, and advantages of the disclosure are apparent from the following detailed description taken in conjunction with the accompanying drawings in which:

FIG. 1 illustrates an exemplary embodiment of a data network.

FIG. 2 illustrates an exemplary embodiment of a node.

FIG. 3 illustrates an exemplary embodiment of a data element.

FIG. 4 illustrates a block diagram of an exemplary method for processing and routing data elements in the network of FIG. 1.

FIGS. 5A and 5B illustrate an exemplary method of operation of the network of FIG. 1.

FIG. 6 illustrates a block diagram of an exemplary method.

FIG. 7 illustrates another exemplary embodiment of a data element.

FIG. 8 illustrates another exemplary embodiment of a data element.

### DETAILED DESCRIPTION

Processing tasks such as iterative and recursive processing of data elements may be performed on a processing network having a variety of processing nodes that are operative to perform specific processing tasks. For example, a data element may be received by a processing network and the data element may be processed to determine a type of data that is present in the data element (e.g., an email message, a video file, an audio file, a text file, an encrypted file). The various nodes in the data network may perform specific processing tasks to process the data element and save metadata associated with the data element in a database or memory system. It is desirable to facilitate efficient processing of the data elements while minimizing consumption of network bandwidth between nodes of the data network.

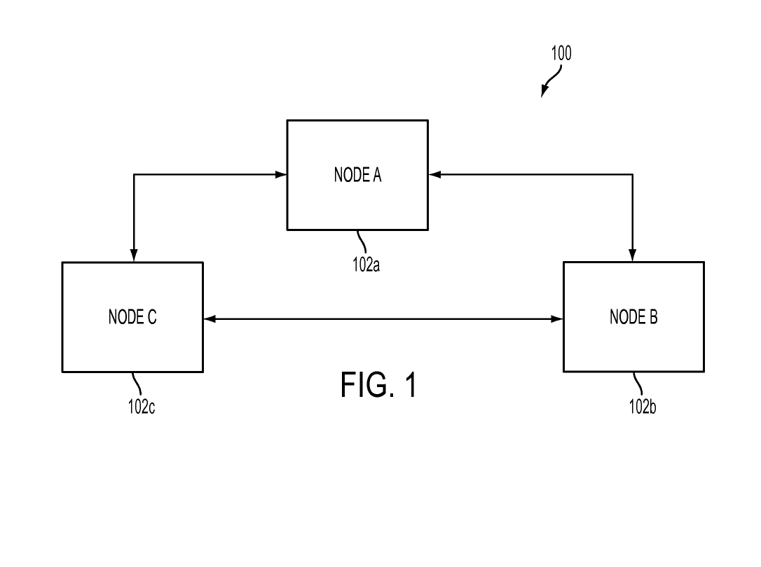

In this regard, FIG. 1 illustrates an exemplary embodiment of a data network 100 that includes communicatively connected processing nodes A-C 102a-c. The nodes 102 may include any type of processing or communications nodes, and the network 100 may include any number of nodes 102. The nodes 102 may be similar or include dissimilar hardware and/or software such that the nodes 102 are operable individually and/or collectively to perform a variety of data processing tasks.

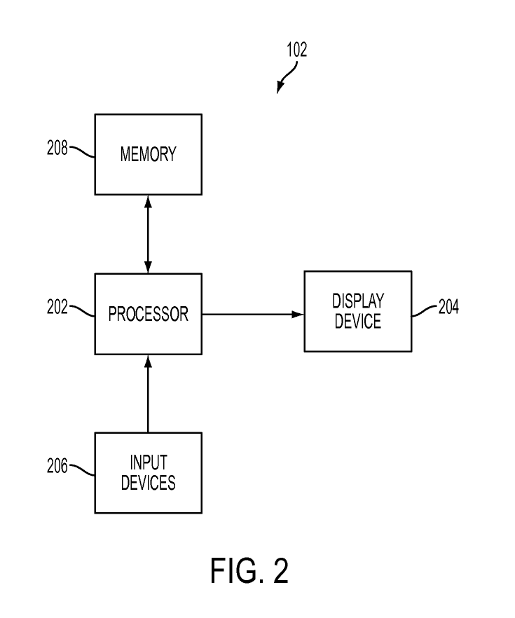

FIG. 2 illustrates an exemplary embodiment of a node 102. The node 102 includes, for example, a processor 202 communicatively connected to a display device 204, input devices 206, and a memory device 208.

As discussed above, the network 100 (of FIG. 1) is operative to receive and process data elements that may include a variety of different types of data in a variety of formats. For example, node 102a may receive a data element, and perform a processing task to determine what type of data is in the data element. In the present example, the data element includes an email message, thus the node 102a may send the data element to another node 102 (e.g., node 102b) in the network that is designated to perform processing of email messages. The node 102b may process the email message (e.g., perform a key word search in the message) and subsequently send the data element to another node 102 for processing if, for example, a particular key word is found, or perform other processing tasks based on a variety of conditions. The exemplary embodiments described herein provide a method and system for routing and processing data elements in the network 100.

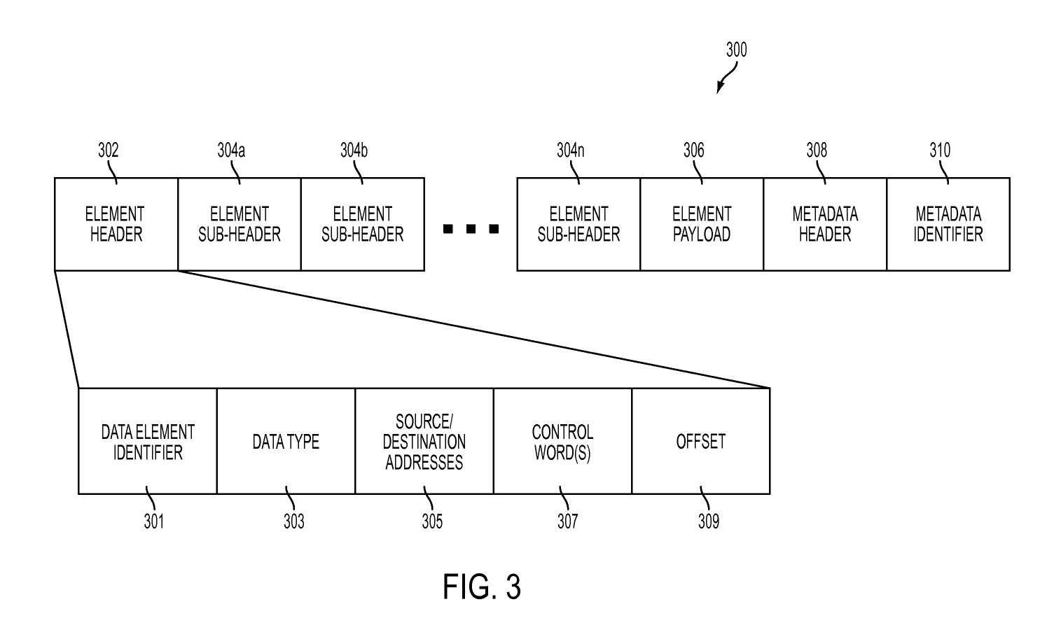

FIG. 3 illustrates an exemplary embodiment of a data element 300. The data element 300 includes an element header field 302 that includes a unique data element identifier field 301, a data type field 303, a source and destination address field 305, a control word field 307 (that may include a plurality of control words), and an offset field 309 (that indicates the start of each sub section e.g., sub-header field 304, payload field 306, and meta header field 308, and the metadata field 310, as an offset from the element header). The data element 300 may include any number of element sub-header fields 304, an element payload field 306 that includes, for example data for processing, a metadata header field 308, and a metadata field 310.

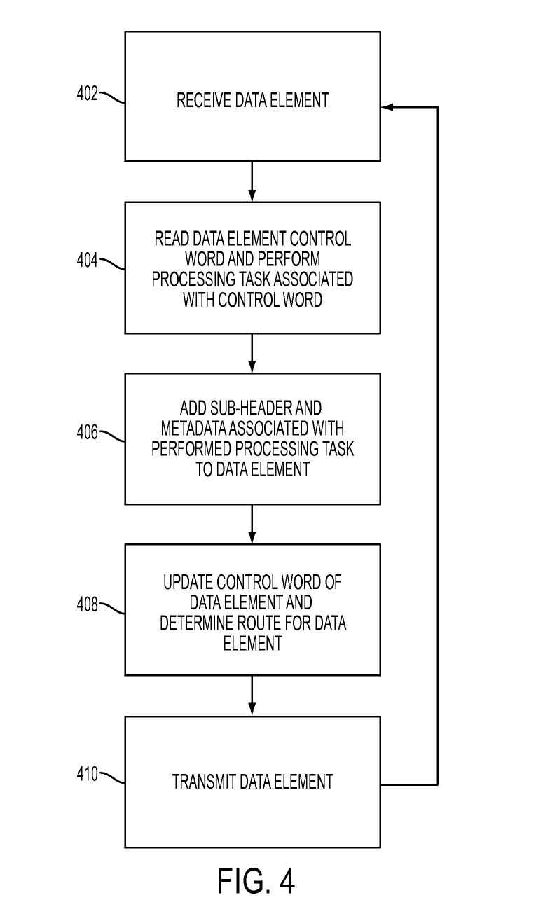

FIG. 4 illustrates a block diagram of an exemplary method for processing and routing data elements in the network 100 (of FIG. 1). In block 402, a data element 400 is received, at a node 102. In block 404, the node 102 reads a control word in the data element 300 and performs a processing task on the data stored in the element payload field 306 associated with the control word. In block 406, the node 102 adds a sub-header to the data element 300 that indicates that the processing task associated with the control word has been performed. The node 102 adds metadata to the metadata header 308 that may include, for example, results of the processing task or other metadata that may be generated and associated with the data in the payload field 306. A metadata identifier 310 is added to the data element 400, which identifies or describes the metadata added to the metadata header 308. The metadata is associated with the data stored in the element payload field 306. In block 408, the node 102 updates the control word in the control word field 307. In this regard, the node 102 may remove the control word associated with the processing task performed by the node 102, and add one or more control words associated with another processing task. The one or more control words associated with another processing task may be determined by, for example, the results of the processing task performed by the node 102. Alternatively, the control word field 307 may have included more than one control word, and the node 102 may remove the control word associated with the performed processing task leaving the remaining control words in the control word field 307. Once the control word field 307 is updated, the node 102 may determine which node in the network 100 is designated or associated with a processing task associated with at least one of the control words in the data element 100, by for example, consulting a look up table having an association between control words and nodes 102. Once another node 102 is identified, the header may be updated with a new source and destination address, and the data element is transmitted in block 410.

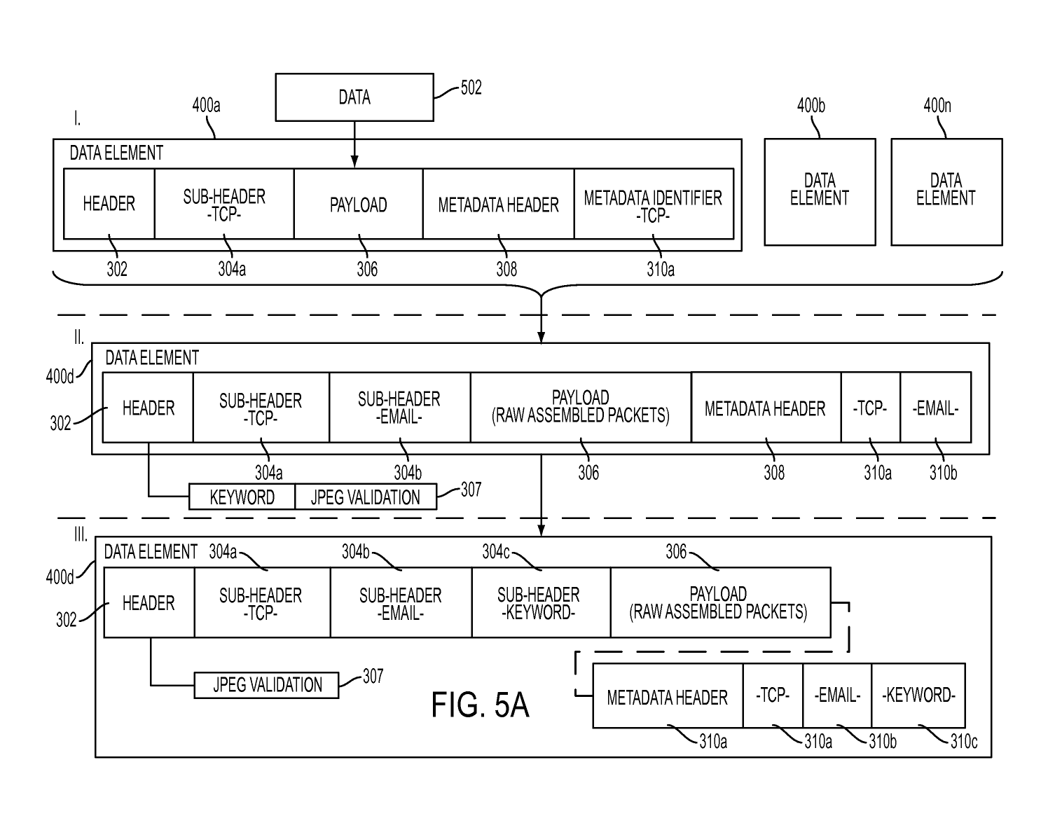

FIGS. 5A and 5B illustrate an exemplary method of operation of the network 100 (of FIG. 1) that is illustrated by a progression of a data element 400 that is modified as the data element is processed by the nodes 102. Referring to FIG. 5A, in section I, data 502 is received by a node 102 (e.g., node 102a, of FIG. 1). The data 502 may include any type of data. In the illustrated embodiment, the data 502 includes an Ethernet frame. The node 102a receives the data 502 and generates a data element 400a that includes the data 502 in the payload field 306. The node 102a generates the header 302 and a sub-header 304a that is associated with the task of generating the data element 400a and may indicate a type of data 502 that has been received. The node 102a adds metadata to the metadata that is associated with the data 502 to the metadata header 308 and adds a metadata identifier 310a to the data element 400a that is associated with the added metadata. The node 102a may also generate other data elements 400b-n that also include data such as, for example, additional Ethernet frames. In section II of FIG. 5A, the node 102a assembles the data of the data elements 400a-n into an assembly of raw data packets and generates a data element 400d that includes the assembly of raw data packets in the payload field 306. The node 102a identifies the type of data in the payload field 306. In the illustrated embodiment, the node 102a has identified the data as including an email having a Joint Photographic Experts Group (JPEG) file. The node 102a may then determine what processing tasks are associated with the identified data by, for example, accessing a look-up table that may include a plurality of identified data types and associated processing tasks. In the illustrated exemplary embodiment, the processing tasks include a keyword search of the email text and a validation of the JPEG file. The node 102a adds control words to the control word field 307 of the header 302 that are associated with each processing task to the header 302. The node 102a may also determine which nodes 102 in the network 100 are designated for performing the determined processing tasks by, for example, accessing a look-up table that includes processing tasks (or control words) and addresses of nodes 102 that are designated for performing particular processing tasks. The node 102a adds an address associated with one of the identified nodes 102 and the source address of the node 102a to the source/destination address field 305 (of FIG. 3) in the header 302. The node 102a adds a sub-header 304b to the data element 400d that indicates that an email processing task has been performed as well as adding metadata associated with the processing task to the metadata header 308 and an associated metadata identifier 310b to the data element 400d. Once the data element 400d has been generated and processed by the node 102a, the node 102a may send the data element 400d to the receiving node (e.g., node 102b).

Referring to section III in FIG. 5A, the node 102b receives the data element 400d and retrieves the control words from the header 302 and determines what processing task is to be performed for a particular control word. In this regard, the node 102b is designated to perform keyword searches of text, thus the node 102b performs a keyword search of the data in the payload 306. When the keyword search is completed, the node 102b adds a sub-header 304c indicative that a keyword search has been performed to the data element 400d. The node 102b also adds results of the keyword search (e.g., a list of one or more keywords found in the keyword search) to the metadata header 308, and a metadata identifier 310c associated with the added metadata. The node 102b may then retrieve the remaining control words to determine whether the node 102b may perform an additional processing task associated with a remaining control word, or as discussed above, identify another node 102 in the network 100 that is designated to perform a processing task associated with one of the remaining control words. The node 102b updates the control word field 307 by removing the control word for the completed processing task (e.g., “keyword”) and may also add additional control words if applicable. In this regard, for example, if a particular key word is found, a control word may be added to the control word field 307 to prompt additional processing tasks by the node 102b or another node 102. The node 102b updates the source/destination address field 305 to include the address of the node 102b (i.e., the source address) and the address of the receiving node 102. (In the illustrated embodiment, the node 102c is designated for performing a JPEG validation processing task, and thus the address of the node 102c is added as the receiving address to the header 302 of the data element 400d.)

Referring to section IV of FIG. 5B, the node 102c has received the data element 400d and performs a JPEG validation processing task to the JPEG file in the payload field 306. The node 102c updates the data element 400d by adding a sub-header 304d, updating the metadata header 308 with the results of the processing task, adding a metadata identifier 310d in a similar manner as discussed above, and updating the control word field 307 and the source/destination address field 305. In the illustrated exemplary embodiment, following the validation of the JPEG file, the node 102c updates the control word field 307 by removing the “JPEG Validation” control word and adding a keyword associated with spectral analysis of the validated JPEG file. In the illustrated exemplary embodiment, the node 102c is also designated to perform spectral analysis of JPEG files, thus, the node 102c performs the spectral analysis processing task and updates the data element 400d in a similar manner as discussed above (adding a sub-header 304e indicating that a spectral analysis has been performed, adding metadata to the metadata header 308, adding an associated metadata identifier 310e, and updating the fields in the header 302). In this regard, referring to section V of FIG. 5B, the “Spectral” control word has been removed from the control word field 307, and thus the control word field 307 is empty. When the control word field 307 is empty, the node 102c may send the data element 400d to a memory or database 504 for archiving. Once the data element 400d is archived, the data element 400d may be retrieved, or metadata of the data element 400d may be retrieved by a user and, for example, presented to the user on a display.

Though the illustrated exemplary embodiment described above provides a serial progression of the data element 400d, alternate exemplary embodiments, may include generating a second data element 400 as a condition of a processing task or a result of a processing task. In this regard, referring to the illustrated example of FIG. 5A, the node 102a may generate a second data element that is substantially similar to the data element 400d such that there are two data elements 400 having the same or similar data stored in the payload field 306, but with different control words (e.g., a first data element 400 having the control word “keyword” and a second data element 400 having the control word “JPEG Validation”). Thus, the data in the data in the payload field 306 may be processed substantially simultaneously by separate nodes 102 performing different processing tasks.

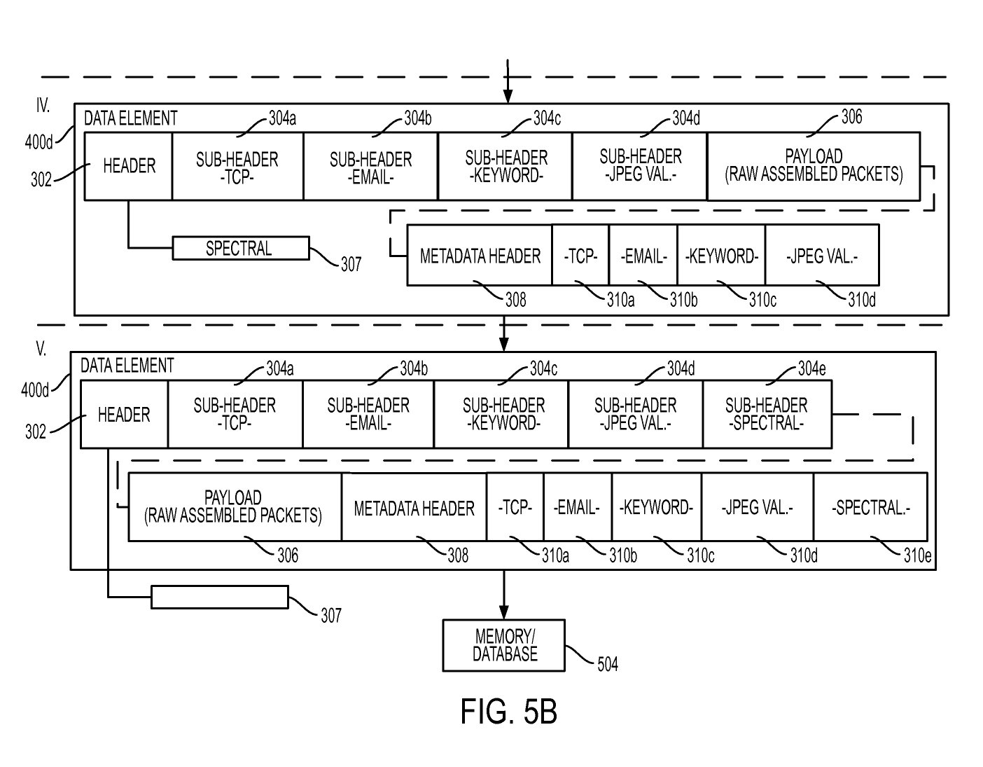

FIG. 6 illustrates a block diagram of an exemplary method that may be performed by any of the nodes 102 (of FIG. 1) of the network 100. In this regard, a time to delete (TTD) indicator may be added to a data element 400 that indicates a time to delete all or portions of the data element 400 (of FIG. 4) once the TTD has been reached. This method facilitates the removal of data from a memory or database to avoid unneeded or lower priority data from consuming needed storage space. Referring to FIG. 6, in block 602, a node 102 receives a data element 400. The node 102 may perform a processing task in a similar manner as discussed above in block 604. In block 606, the node 102 determines the associated TTD for data processed or generated by the processing task. In this regard, a particular processing task may have an associated TTD. Alternatively, the results of the processing task may be associated with one or more TTDs. Thus, the TTD may be different for different data elements 400 depending on the type of data stored in the data element 400, the processing tasks performed on the data element 400, and/or the results of the processing tasks performed on the data element 400. For example, after a keyword search performed by a node 102 does not result in any keywords being found, a TTD may be added to the data element 400 in block 610. Alternatively, if a particular keyword or words are found, a different TTD (e.g., a longer TTD) may be added to the data element 400 if desired. A TTD is added to the data element 400 prior to sending the data element 400 to another node 102 for processing or storage.

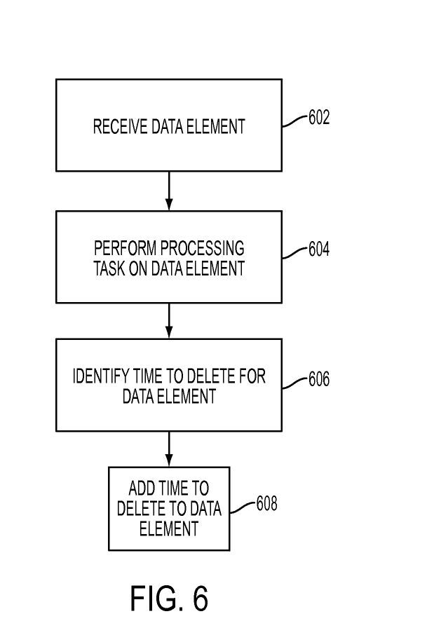

FIG. 7 illustrates an exemplary embodiment of a data element 700 that includes a time to delete field 702 that is included in the element header 302. The TTD field 702 may include a time (e.g., a date and time) to delete all or a portion of the data element 700. For example, the TTD may include an indicator to delete the contents of the element payload field 306 at a particular time, and an indicator to delete all or a portion of the contents of the metadata header field 308 and the metadata identifier fields 310. Thus, the TTD may be used to sequentially delete portions of a data element 400 over time, or the entire data element 400 at a particular time.

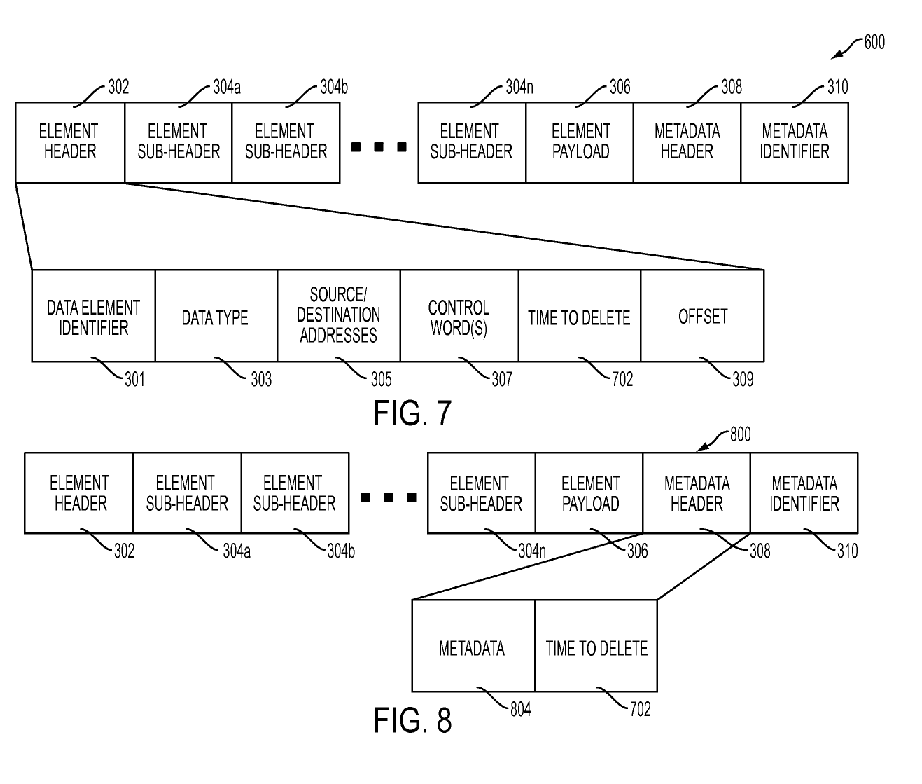

FIG. 8 illustrates an alternate exemplary embodiment of a data element 800 that includes the TTD field 702 in the metadata header 308 field of the data element 700. The TTD may be used in a similar manner as described above. Including the TTD field 702 in the metadata header field 308 may allow the TTD to be accessed by a processer without potential processing and network overhead that may be associated with accessing a TTD located in the element header field 302.

The technical effects and benefits of the exemplary embodiments described herein provide a method and system for processing and generating data elements by multiple nodes that may perform a variety of processing tasks, and removing portions of data elements from storage at a particular time that may be assigned while processing the data elements with the system.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated

The flow diagrams depicted herein are just one example. There may be many variations to this diagram or the steps (or operations) described therein without departing from the spirit of the disclosure. For instance, the steps may be performed in a differing order or steps may be added, deleted or modified. All of these variations are considered a part of the claimed disclosure.

While an exemplary embodiment of the disclosure has been described, it will be understood that those skilled in the art, both now and in the future, may make various improvements and enhancements which fall within the scope of the claims which follow. These claims should be construed to maintain the proper protection for the invention first described.

hat is claimed is:

1. A method for processing data, the method comprising:
receiving a data element in a first processing node, the data element including data;
reading a first control word in data element and perform a first processing task with the data with a processing portion of the first processing node, the first processing task associated with the first control word;
adding a first sub-header associated with the first processing task to the data element;
adding metadata associated with the first processing task to the data element;
removing the first control word from the data element;
determining whether a second processing task should be performed with the data; and
adding a second control word to the data element responsive to determining that a second processing task should be performed with the data.

2. The method of claim 1, wherein the second control word is associated with the second processing task.

3. The method of claim 1, further comprising:
determining whether the first processing node is designated to perform the second processing task; and
performing the second processing task with the data with the first processing node responsive to determining that the first processing node is designated to perform the second processing task.

4. The method of claim 1, further comprising:
determining whether the first processing node is designated to perform the second processing task;
identifying a second processing node designated to perform the second processing task responsive to determining that the first processing node is not designated to perform the second processing task;
updating a receiving address of the data element to include an address of the second processing node; and
sending the data element to the second processing node.

5. The method of claim 1, further comprising:
determining whether a time to delete is associated with results of the first processing task;
adding a time to delete to the data element responsive to determining that a time to delete is associated with results of the first processing task.

6. The method of claim 5, wherein the time to delete indicates a time to delete a portion of the data element.

7. The method of claim 5, wherein the time to delete is added to a header field of the data element.

8. The method of claim 5, wherein the time to delete is added to a metadata header field of the data element.

9. A system for processing data, the system comprising:
a first processing node comprising a processor operative to:
receive a data element in a first processing node, the data element including data;
reading a first control word in data element and perform a first processing task with the data with a processing portion of the first processing node, the first processing task associated with the first control word;
add a first sub-header associated with a first processing task to data element;
add metadata associated with first processing task to data element;
remove the first control word from data element;
determine whether a second processing task should be performed with the data; and
add a second control word to the data element responsive to determining that a second processing task should be performed with the data.

10. The system of claim 9, wherein the second control word is associated with the second processing task.

11. The system of claim 9, wherein the first processing node is further operative to:
determine whether the first processing node is designated to perform the second processing task; and
perform the second processing task with the data with the first processing node responsive to determining that the first processing node is designated to perform the second processing task.

12. The system of claim 9, wherein the first processing node is further operative to:
determine whether the first processing node is designated to perform the second processing task;
identify a second processing node designated to perform the second processing task responsive to determining that the first processing node is not designated to perform the second processing task;
update a receiving address of the data element to include an address of the second processing node; and
send the data element to the second processing node.

13. The system of claim 9, wherein the first processing node is further operative to:
determine whether a time to delete is associated with results of the first processing task;
add a time to delete to the data element responsive to determining that a time to delete is associated with results of the first processing task.

14. The system of claim 13, wherein the time to delete indicates a time to delete a portion of the data element.

15. The system of claim 13, wherein the time to delete is added to a header field of the data element.

16. The system of claim 13, wherein the time to delete is added to a metadata header field of the data element.

17. A method for processing data, the method comprising:
receiving a data element including data;
performing a first processing task with the data with a processor;
determining whether a time to delete is associated with a result of the first processing task;
adding a time to delete to the data element responsive to determining that a time to delete is associated with a result of the first processing task.

18. The method of claim 17, wherein the time to delete indicates a time to delete a portion of the data element.

19. The method of claim 17, wherein the time to delete is added to a header field of the data element.

20. The method of claim 17, wherein the time to delete is added to a metadata header field of the data element.
